(19) United States
(12) Patent Application Publication
(10) Pub. No.: US 2026/0152817 A1
(43) Pub. Date: Jun. 4, 2026

(54) HIGH STRENGTH STEEL STRIP OR SHEET EXCELLENT IN DUCTILITY AND BENDABILITY, MANUFACTURING METHOD THEREOF, CAR OR TRUCK COMPONENT

(71) Applicant: TATA STEEL NEDERLAND TECHNOLOGY B.V., Velsen-Noord (NL)

(72) Inventors: Shangping CHEN, Beverwijk (NL); Richard MOSTERT, Heemskerk (NL)

(73) Assignee: TATA STEEL NEDERLAND TECHNOLOGY B.V., Velsen-Noord (NL)

(21) Appl. No.: 18/713,424

(22) PCT Filed: Dec. 21, 2022
(86) PCT No.: PCT/EP2022/087319

§ 371 Date: May 24, 2024

(30) Foreign Application Priority Data
Dec. 24, 2021 (EP) 21217743.0

(51) Int. Cl. C21D 9/52; B32B 15/01; C21D 1/18; C21D 1/84; C21D 6/00; C21D 8/0221; C21D 8/0247; C21D 8/0278; C21D 9/46; C22C 38/00; C22C 38/02; C22C 38/04; C22C 38/06; C22C 38/42; C22C 38/44; C22C 38/46; C22C 38/48; C22C 38/50; C22C 38/54; C22C 38/58

(52) U.S. Cl. CPC C21D 9/52; C21D 1/18; C21D 1/84; C21D 6/004; C21D 6/005; C21D 6/008; C21D 8/0226; C21D 8/0236; C21D 8/0263; C21D 8/0278; C21D 9/46; C22C 38/001; C22C 38/002; C22C 38/02; C22C 38/04; C22C 38/06; C22C 38/42; C22C 38/44; C22C 38/46; C22C 38/48; C22C 38/50; C22C 38/54; C22C 38/58; B32B 15/012; B32B 15/013; B32B 2250/05; B32B 2250/40; B32B 2311/20; B32B 2311/24; B32B 2311/30; C21D 2211/001; C21D 2211/005; C21D 2211/008

(57) ABSTRACT

A high strength steel strip or sheet excellent in ductility and bendability. A method for producing such steel strip or sheet.

### FIELD OF THE INVENTION

The invention relates to a high strength steel strip or sheet excellent in ductility and bendability. The invention also relates to a method for producing such steel strip or sheet.

### BACKGROUND OF THE INVENTION

In recent years, high-strength steel sheets have been increasingly applied to vehicle body components such as frames to reduce weight. However, in general, as the strength of the steel increases, the formability such as bendability decreases, making it difficult to form a member of an automobile from a high-strength steel sheet. Thus, development of steels having high strength and high formability has been required.

Various types of steel sheet have been developed to effectively utilize the TRIP (Transformation-Induced Plasticity) effect which implies a phase transformation in the material, typically when a stress is applied. TRIP steels possess a microstructure consisting of (retained) austenite with the appropriate thermodynamic instability such that transformation to martensite is achieved during loading or deformation.

For example, U.S. Pat. No. 5,470,529-A1 discloses a high tensile strength, hot or cold-rolled steel sheet having improved ductility and hole expandability that consists essentially, on a weight basis, of: C: 0.05-0.3%, Si: 2.5% or less, Mn: 0.05-4%, Al: greater than 0.10% and not greater than 2.0% wherein 0.5%≤Si+Al≤3.0%, optionally one or more of Cu, Ni, Cr, Ca, Zr, rare earth metals (REM), Nb, Ti, and V, and a balance of Fe and inevitable impurities with N being limited to 0.01% or less. The steel sheet has a structure comprising at least 5% of retained austenite in ferrite or in ferrite and bainite. The high expandability is related to the high content of Al.

US2005081966-A1 discloses a high tensile strength steel sheet excellent in processibility which can satisfy a strength, a total elongation, and stretch-flanging property at a further high level and comprises a matrix microstructure of tempered martensite or tempered bainite and, if necessary, ferrite, and a second phase of retained austenite, wherein the steel comprises (in wt. %) C: 0.10 to 0.6%, Si: 1.0% or smaller, Mn: 1.0 to 3.0%, Al: 0.3 to 2.0%, P: 0.02% or smaller, S: 0.03% or smaller and a 5 to 40 area % of retained austenite.

Due to the mixed effect of soft ferrite and hard martensite and the TRIP effect of the retained austenite, TRIP steels have a low yield ratio and excellent uniform elongation. However, the steels according to the state of the art suffer from poor bendability. Multi-phase microstructures involving microstructure containing ferrite in combination with a hard martensite phase and/or a hard bainite phase show inferior bendability due to martensite cracking and void formation at the interface between the ferrite and martensite as the local ductility in that portion is lowered since the difference in hardness between ferrite and a martensite phase or a bainite phase is large. The bendability decreases as the strength is increased, which is related to the increase in the amount of martensite. For this reason, TRIP steels currently used do not obtain good processing results in bending forming when manufacturing a frame or the like.

### OBJECT OF THE INVENTION

It is an object of the invention to find a composition of that provides a high-strength steel sheet having excellent elongation and bendability.

It is also an object of the invention to provide a method for producing said a high-strength steel sheet having excellent elongation and bendability.

### DESCRIPTION OF THE INVENTION

An object is reached with the steel strip according to claim 1. Preferred embodiments are provided by the dependent claims.

The steel strip according to the invention solves the problem of combining high bendability with high strength by modifying the surface layer of a multi-phase microstructure TRIP steel by controlling the chemical composition of the steel, and by controlling the silicon and aluminium content of the steel in particular without the need to change the annealing atmosphere in a continuous annealing line, and thereby avoid the risk of undesired oxidation of the surface during continuous annealing.

In the context of this invention a sheet is defined as a piece that is produced by cutting it from a strip. The sheet may have any shape such as rectangular, square, circular or a more complicated shape, e.g. for use as a blank in a stamping operation. For ease of handling strips are usually provided in a coiled form, whereas sheets are usually provided in a stacked form.

The surface layer is formed due to the formation of the C gradient in the thickness direction in the hot-rolled strip. A decrease in the C content in the surface layer of a steel sheet occurs during hot processing and coiling processing. The presence of Al accelerates the decarburization process. For the purpose of this invention the depth at which the C content is 0.080 wt. % or lower is defined as the surface layer (see FIGS. 1 and 6). The higher the Al content is, the deeper the surface layer. The ferrite fraction at the depth of the C content of 0.08 wt. % is about 90% for the invented composition range. Thus, the ferrite fraction in the surface layer is higher than 90% because the presence of the C gradient.

The depth of the surface layer produced in the hot-rolled strips will be reduced in thickness during cold rolling. By controlling the thickness of hot-rolled strips in combination with the cold-rolling reduction, the depth of the surface layer in the final products for a specific composition can be also adjusted. For example, for a steel composition containing less Al, the thickness of the hot-rolled strip can be smaller and a lower cold reduction can be applied, while for a higher Al content, the thickness of the hot-rolled strip can be larger and a higher cold reduction is applied.

So, in this invention, satisfactory strength and ductility are achieved by specifying a multiphase microstructure in the bulk of the steel strip's matrix, and satisfactory strength and bendability are achieved by appropriately controlling the microstructure of the surface layer which is composed mainly of ferrite (at least 90%) and a small amount of second phase comprising pearlite, bainite and/or martensite and carbides. The surface layer in the final cold-rolled sheet is preferably between 15 and 50 μm in thickness. To ensure a good bendability, a surface layer of at least 15 μm in the final cold-rolled sheet is needed and at least 20 μm is preferable. A maximum value of 50 μm is needed, and a maximum value of 40 μm is preferable.

It is preferable that the two surface layers together comprise at most 10% of the thickness of the final cold-rolled sheet, and preferably at most 8%, and more preferably at most 6%. A suitable minimum value is at least 2%, preferably 3% and more preferably 4%. So a final cold-rolled sheet of 1 mm thick with a value of 5% (assuming the surface layers are equal in thickness on both sides) comprises a surface layer of 25 μm on each side and a base layer of 950 μm. For a 2 mm cold rolled strip or sheet the same 5% results in a 50 μm surface layer on each side and a 1.9 mm thick base layer.

Preferably the steel strip or sheet according to the invention has a value for TE*UTS of at least 18000 MPa %, and more preferably of at least 20000 MPa, wherein UTS is the ultimate tensile strength and TE is the total elongation.

Since the bendability (abbreviated as BA) is an important property of the steel strip or sheet according to the invention, it is preferable that BA_{avg}*UTS*TE>2100000 (° MPa %), wherein BA_{avg} is the average of BA-L (the bending angle when the bending axis is parallel to the rolling direction of the steel strip or sheet) and BA-D (the bending angle when the bending axis is perpendicular to the rolling direction of the steel strips or sheet). In this parameter the most important properties are combined: global formability (TE), strength (UTS) and bendability (BA).

According to a second aspect of the invention there is provided a method for producing the steel strip according to claim 12. Preferred embodiments are provided by the dependent claims.

In bending deformation, cracks often initiate at the surface of the steel sheet where the deformation is maximum. Thus, fracture from the surface of the steel sheet is the dominant processing limit for parts using ultra-high-strength steel sheets. The inventors found that the bending performance is greatly improved by using a layer mainly composed of ferrite as the surface layer of the steel sheet. A ferrite phase in a surface layer has a role in dispersing the maximum strain produced by the bending operation. Therefore to obtain a steel sheet having excellent bendability, the steel sheet surface is modified to obtain a surface layer mainly composed of ferrite which the inventors accomplish by combining a balanced chemical composition with a tailored annealing cycle.

In the context of this invention hot-dip galvanising (hot-dip coating with zinc or a zinc alloy) includes hot-dip aluminizing (hot-dip coating with commercially pure aluminium or an aluminium alloy). Alternatively the annealed strip may be provided with a metallic coating by electrodeposition.

The inventors have found that by a careful selection of the amounts of the main constituting elements of the steel, being carbon, manganese, silicon, aluminium, chromium and boron, a high strength hot dip galvanised steel strip can be produced that has the required formability, homogeneity, processability, strength and elongation, while at the same time providing acceptable weldability, coatability and surface quality.

To obtain high strength, high elongation and good bendability, the invented steel strip or sheet has a clearly distinguishable base microstructure and surface layer microstructure (all microstructural percentages are given in vol. % unless indicated otherwise). The base microstructure consists of ferrite of 15 to 85%, (partitioned martensite+bainitic ferrite) of 0 to 75%, residual austenite of 5 to 20%, fresh martensite of 10% or less, and pearlite of 5% or less and the surface layer microstructure consists of ferrite of 90% or more with the remainder consisting of at most 10% in total of pearlite, martensite, bainite and residual austenite. Here, the base microstructure is defined as the microstructure at a depth of t/4 (t is the thickness of the steel strip or sheet). The base microstructure ensures high strength and high elongation. The surface microstructure is to obtain a high bendability.

### Base Microstructure

Ferrite: 15 to 85%: Ferrite is effective for improving ductility. In order to achieve good ductility, the minimum fraction of a ferrite phase is 15%. It is preferable that the fraction of a ferrite phase be 30% or more, or more preferably 35% or more. To achieve high strength it is necessary to limit the amount of ferrite to 85%.

Bainitic Ferrite and/or partitioned martensite: 0 to 75%: Bainitic ferrite and bainite have a strength which is in the middle between ferrite, which is softer, and martensite, which is harder, and contributes to improving the balance between strength and ductility. Partitioned martensite is martensite obtained by overageing the quenched martensite. Carbon is rejected from martensitic ferrite and enriched into the remaining austenite.

At low values of BF+PM the strength may be somewhat lower but the ductility is improved. To achieve sufficient strength, the sum of the fraction of bainite phase and the fraction of partitioned martensite phase is set to be 10% or more. On the other hand, in the case where the fraction of a bainite phase and/or a partitioned martensite phase is more than 75%, there is an excessive increase in strength, and is not possible to achieve the desired bending workability. Therefore, the sum fraction of a bainite phase and partitioned martensite phase is set to be 75% or less. The preferred range of BF+PM is 10 to 75%. It is more preferable that the sum fraction of a bainite phase and partitioned martensite phase be in the range of 20 to 60%.

Residual Austenite: 5 to 25%: The residual austenite produces the TRIP effect during forming which to significantly improves elongation. On the other hand, the residual austenite partially or completely transforms to martensite during forming which deteriorates bendability. Therefore, it is preferable that the volume fraction of the residual austenite in the microstructure of the base steel sheet is 5 to 20%.

Fresh Martensite: 0-10%: The fresh martensite is martensite which does not contain iron-based carbides, and is very hard and brittle. The fresh martensite significantly improves tensile strength. On the other hand, fresh martensite becomes a fracture origin and significantly deteriorates ductility and bendability. Accordingly, fresh martensite is limited to at most 10% in the base steel. To increase bendability, fresh martensite is preferably 8% or less, and even more preferably 5% or less.

Other Structures: The structure of the base steel strip or the steel sheet may contain a structure such as coarse cementite or pearlite other than the above-described structures. Coarse cementite refers to cementite having a nominal particle size of 2 μm or more, which separately exists at crystal grain boundaries without being included in any metallographic structure. Cementite can be an origin of cracking or void formation during deformation. When there is a large amount of coarse cementite and pearlite in the structure of the base steel, ductility deteriorates. Thus, the fraction of coarse cementite in the base microstructures is preferably 5% or less, and more preferably 3% or less. Pearlite is less than 5% and preferably the pearlite content is at most <2 vol. % and more preferably at most 1% and even more preferably absent, i.e. below the detection level.

### Surface Microstructure

Ferrite: 90% or more: In a surface layer that is a region within a depth from the surface in the thickness direction, the fraction of a ferrite phase is higher than 90%. The presence of a ferrite phase in the surface layer is an important criterion for determining the quality of the high-strength steel sheet according to aspects of the present invention. To achieve good bendability, it is necessary that the fraction of the ferrite phase in a surface layer be 90% or more. The thickness of the surface layer is 10 to 50 μm. If the thickness of the surface layer is too small, the function to improve the bendability is not effective. If the thickness of the surface layer is too large, the strength of the steel sheet becomes too low.

Other microstructures: less than 10%. This includes partitioned martensite and bainitic ferrite, fresh martensite, residual austenite, pearlite and carbides.

Since the interfaces between the ferrite and other microstructures such as partitioned martensite and bainitic ferrite, fresh martensite, residual austenite and carbides can be the origin of a crack during bending it is necessary to limit the fraction of these microstructures in the surface of the steel sheet. Thus, the fraction of these microstructures in the surface part of the steel sheet is set to 10% or less, preferably 8% or less, and more preferably 5% or less.

### Chemical Composition

The reason for the amounts of the main constituting elements in the steel according to the invention is as explained below. All compositions throughout are given in weight percent (wt. %) unless indicated otherwise. It is noted that, although the alloying elements as given below must be applied in a balanced manner to achieve the desired results, the elements may be varied independently of each other within the boundaries as described for the individual elements herein below.

C: 0.10 to 0.30%. C is an element which is indispensable for increasing strength and ductility by forming a mixed microstructure. To produce such effects, it is necessary that the C content be 0.10% or more. On the other hand, in the case where the C content is more than 0.30%, the weldability becomes insufficient. Therefore, the C content is set to be in the range of 0.10% to 0.30%. The C content is preferably 0.12% or more, and more preferably 0.15% or more. The C content is preferably 0.28% or less, and more preferably 0.26% or less.

Mn: 0.80 to 3.00%. Mn is, like C, indispensable for achieving a desired microstructure and strength. In addition, Mn is important for stabilizing an austenite phase to inhibit the formation of pearlite during cooling in a continuous annealing process. To produce these effects, it is necessary that the Mn content be 0.80% or more. The Mn content is, for further increasing the strength, preferably 1.00% or more, and more preferably 1.20% or more. However, when the Mn content is more than 3.00%, a coarse Mn concentrated banded microstructure is generated in centre portion of the base steel sheet, embrittlement occurs easily, and there is a decrease in bending workability. Therefore, the Mn content is set to be 3.00% or less, preferably 2.80% or less, or more preferably 2.60% or less.

Si: 0.010 to 1.50%. Si is an element which is effective for increasing the strength of steel without significantly decreasing the ductility of steel. In addition, Si facilitates the partitioning of C into an austenite phase, and retards the precipitation of cementite in the base steel during an overageing process to improve the strength and formability. Further, Si facilitates a decarbonizing reaction to soften the steel sheet surface. To produce these effects, it is necessary that the Si content be 0.30% or more. However, in this invention, Al is added to contribute to similar effects. Therefore, the lower limit of the Si content is not critical, and it is possible to lower the Si content to 0.010%. A suitable minimum amount is 0.030%. Addition of Si in excess of 1.50% results in high-Si scales to form in an appreciable amount, thereby deteriorating the surface appearance and surface processability by alloyed galvanizing. Therefore, the Si content is limited to 1.50% or less and preferably 1.20% or less.

Al: 0.50 to 2.00%. Al facilitates a decarbonizing reaction to soften the steel sheet surface. Like Si, Al also supresses the formation of carbides during overageing. To obtain such effects, it is necessary that the Al content is 0.50% or more. However, when the Al content is more than 2.00%, the phase transformation temperatures Ac₃ and Ar₃ are significantly increased so that it is difficult to obtain the steel sheet products from the current available production lines, thus, the upper limit of Al content is set to 2.00%. The Al content is preferably 1.80% or less, and more preferably 1.70% or less.

Al+Si: 0.50-2.5%. Si and Al both facilitate a decarbonizing reaction to soften the steel sheet surface layer. To produce sufficient decarbonizing, the amount of Al+Si is 0.50% or more, preferably, 1.00% or more, more preferably 1.1% or more and most preferable 1.2% or more. When (Al+Si) is too high, the decarbonized layer becomes too thick resulting in too much loss of strength. Therefore, the amount of Al+Si is 2.5% or less.

P: 0.001 to 0.050%. P is effective for increasing the strength of steel and for maintaining desired retained austenite. To produce such an effect, it is preferable that the P content be 0.001% or more. On the other hand, if the P content is more than 0.050%, there is a decrease in weldability. Therefore, the P content is set to be 0.050% or less. In addition, in the case where more excellent weldability is required, it is preferable that the P content be 0.025% or less.

S: 0.0005 to 0.0300%. S couples with Mn to form coarse MnS and decreases ductility and formability. Thus, the S content is set to be 0.0300% or less, preferably 0.0200% or less and more preferably 0.0100% or less. However, reducing the S content to less than 0.0005% accompanies a large increase in manufacturing costs, and thus the lower limit of the S content is set as 0.0005%.

N: 0.0005 to 0.0100%. N is present as an inevitable impurity in a steel. N forms a coarse nitride and deteriorates ductility and bendability. When the N content is more than 0.0100%, this tendency becomes significant, and thus the upper limit value of the N content is set to 0.0080%, preferably 0.0060% or less. It is preferable that the N content be as small as possible. However, reducing the N content to less than 0.0005% accompanies a large increase in manufacturing costs, and thus, 0.0005% is set as the lower limit value.

The base steel sheet may optionally further contain one or more of elements such as Cr, Ni, Cu, Mo, B, Ti, Nb and V. If any one or more of these elements is not added during steelmaking, then the respective element is absent completely (0%) or present at most at a residual element or impurity level because in practical steelmaking it may not be possible to reach the value of 0%, because some traces may inevitably remain present in the steel. Any one of these elements may be present in the steel as trace elements or residual elements in the amounts up to the lower limits set below, respectively. When an element is at residual element level, the elements are deemed not to affect the properties or processability of the steel in a significant way, and in these cases the cost of removing these elements further exceeds the expected benefits of a further reduction, even if it were technically feasible to reduce the level further. To obtain any degree of the desired effect, these elements should be added above the lower limits.

Cr: 0.04 to 0.30%. Cr suppresses phase transformation at high temperature and is an element effective for increasing strength, and may be added in place of part of C and/or Mn. An appropriate amount of Cr incorporated results in a satisfactory strength-ductility balance. However, if the Cr content is more than 0.30%, the corrosion resistance of the steel may deteriorate. Therefore, the Cr content is set to 0.30% as maximum value.

Ni: 0.04 to 1.00%. Ni suppresses phase transformation at high temperature and is an element effective for increasing strength, and may be added in place of part of C and/or Mn. When the Ni content is more than 1.00%, weldability is impaired, and thus, the Ni content is preferably 1.00% or less. Preferably the Ni content is 0.50% or less.

Cu: 0.04 to 1.00%. Cu is an element which increases strength by existing as fine particles in steel, and can be added in place of part of C and/or Mn. When the Cu content is more than 1.00%, weldability is impaired, and thus, the Cu content is preferably 1.00% or less. Preferably the Cu content is 0.50% or less.

Mo: 0.04 to 0.50%. Mo retards the bainitic transformation and promotes solid-solution hardening, and may be added in place of part of C and/or Mn. When the Mo content is more than 0.50%, workability during hot working is impaired and productivity decreases, and thus, the Mo content is preferably 0.50% or less. Preferably the Mo content is 0.30% or less.

Nb: 0.005 to 0.10%. Nb is effective for increasing the strength of steel and for refining microstructure of steel by forming carbonitrides in steel. To produce such effects, the Nb content is set to be 0.005% or more. On the other hand, in the case where the Nb content is more than 0.060%, since there is a significant increase in the amount of carbonitrides, it is not possible to achieve a desired bending workability. Therefore, the Nb content is set to be in the range of 0.005% to 0.100% and preferably in the range of 0.05 to 0.060%.

Ti: 0.005 to 0.040%. Ti is, like Nb, effective for increasing the strength of steel and for refining the microstructure of steel by forming carbonitrides in steel. In addition, Ti inhibits the formation of B nitrides, which cause a decrease in hardenability. To produce such effects, the Ti content is set to be 0.005% or more. On the other hand, in the case where the Ti content is more than 0.040%, since there is a significant increase in the amount of carbonitrides, it is not possible to achieve a desired bending workability. Therefore, the Ti content is set to be in the range of 0.005% to 0.100 and preferably in the range of 0.05 to 0.040%.

V: 0.005 to 0.20%. V is an element which contributes to increasing strength of the base steel sheet by precipitate strengthening or fine grain strengthening. However, when the V content is more than 0.150%, precipitation of carbonitrides increases and formability deteriorates, and thus the V content is preferably 0.150% or less.

B: 0.0005 to 0.0030%. B is a chemical element which is important for inhibiting the formation of ferrite during cooling in a continuous annealing process by increasing the hardenability of steel. In addition, B is effective for controlling the decarburization zone in a surface layer. To produce such effects, the B content is set to be 0.0005% or more. On the other hand, in the case where the B content is more than 0.0030%, such effects become saturated, and there is an increase in rolling load in hot-rolling and cold-rolling. Therefore, the upper limit of B content is set to be 0.0030%.

The base steel sheet may further contain at least one from elements such as Ca, Mg, Zr and REM.

Zr: 0.010 to 0.10%. Zr additions in steels may reduce the austenite grain size and strength of the steel by precipitate strengthening.

Ca, and REM are elements effective for improving formability by controlling a form of sulphide in the steel and for improving castability of the steel by preventing clogging, and therefore one or two or more of these elements may be added. REM is an abbreviation of Rare Earth Metals and refers to any combination of the elements belonging to the lanthanoid series. When a total content of REM is more than 0.1000%, or the total content of Ca is more than 0.010%, it is possible that ductility is impaired and the amount of REM is therefore 0.1000% or less and the amount of Ca is 0.010% or less. In continuous casting machines, some inclusions occurring in molten steel have a tendency to block the nozzle, resulting in lost output and increased costs. Calcium treatment reduces the propensity for blockage by promoting the formation of low melting point species which will not clog the caster nozzles. A suitable minimum amount of Ca is 0.0002%. It is also possible to add no calcium when the sulphur content is very low. Magnesium or Rare Earth Metals (REM) may be added for similar reasons as Ca. A maximum for Mg is set at 500 ppm for Mg.

The steel melt is preferably produced in a BOS-process (Basic Oxygen Steelmaking) based on pig iron from blast furnaces or iron from DRI-type processes. The BOS-process is preferable over a scrap based Electric Arc (EA)-process because of its ability to control the chemistry and the lower levels of unavoidable impurities that can be reached in the BOS-process compared to the EA-process. In the context of this invention unavoidable impurities and residual elements mean the same in that the level of unavoidable impurities and the level of residual elements are determined by the technical or economic incapability to lower the level of an element below these levels.

The invention is also embodied in a steel strip or sheet wherein the base layer comprises, in wt. %:

| | | | |
|---|---|---|---|
| C: | 0.124-0.215 | Si: | 0.029-1.484 |
| Mn: | 1.179-2.346 | Si + Al: | 1.292-2.455 |
| Al: | 0.518-1.796 | N: | 0.0020-0.0050 |
| Cr: | at most 0.050 | Cu: | at most 0.050 |
| Ni: | at most 0.080 | | |

In a preferable embodiment the steel strip or sheet comprise, in wt. %:

| | | | |
|---|---|---|---|
| Cr: | 0.010-0.050 | Nb: | at most 0.010 |
| Ni: | 0.007-0.080 | Ti: | at most 0.005 |
| Cu: | 0.010-0.050 | Ca: | at most 0.0010 |

The steel melt is continuously cast into a slab or thick strip (jointly referred to as slab in the following) by known means.

In hot-rolling of the slab, the slab temperature is required to be sufficiently high to secure a finish rolling temperature of the Ar₃ temperature or higher, to secure a manageable rolling load during hot-rolling, avoid shape defects and control the dissolution of precipitated elements prior to hot-rolling.

The Ars transformation point is calculated by the following expression using the content (wt. %) of each element and the strip thickness t (mm).

$${Ar}_{3} = 901 - 325 C + 33 Si - 92 ( Mn + Ni / 2 + Cr / 2 + Cu / 2 + Mo / 2 ) + 52 Al + 0.35 ( t - 8 ) \qquad ( 1 )$$

The slab temperature prior to hot-rolling is brought to 1200° C. or higher. Setting an excessively high heating temperature is not preferable in terms of energy consumption and thus a suitable upper limit of the slab temperature is 1350° C. or lower. In most conventional hot strip mills the reheating temperature is between 120° and 1300° C. In case of producing the steel according to the invention in a thin slab casting and direct rolling facility, where the slab is rolled immediately after casting the slab temperature prior to hot-rolling is preferably between 1100° C. and 1200° C.

The hot-rolling needs to be completed at a finish rolling temperature of Ar₃ or higher. When the finish rolling temperature is lower than Ars then the steel is rolled in the two-phase region in which ferrite and austenite co-exist. Thus, a hot-rolled sheet structure becomes a heterogeneous duplex grain structure and the heterogeneous structure remains even after being subjected to cold-rolling and continuous annealing steps, resulting in that the ductility and the bendability are deteriorated.

On the other hand, when an excessively high finish hot-rolling temperature is set, the slab heating temperature has to be set excessively high in order to secure the temperature. Thus, the upper limit of the finish rolling temperature is desirably 1100° C. or lower.

The thickness of the hot-rolled strips is in the range from 2 to 6 mm. The thickness of the hot-rolled strips should be selected according to the composition of the steel and cold-rolling reduction required to ensure a surface layer according to the invention of between 15 and 50 μm, preferably between 20 and 40 μm in the final cold-rolled sheet. On the other hand, the steel composition, the hot rolled strip thickness and the cold rolling reduction should be jointly selected to produce the two surface layers together in the cold rolled strip comprising at most 10% of the thickness of the final cold-rolled strip, and preferably at most 8%, and more preferably at most 6% to prevent the strength loss.

The cooling rate after finishing rolling is set to 20° C./s or less to reduce the formation of a banded structure. In particular, it is effective to slowly cool in the temperature range of 800 to 700° C. To prevent an excessive increase in thickness of the oxide formed on the surface of the hot-rolled steel strip, a coiling temperature after hot-rolling is 750° C. or lower. To further increase pickle ability of the hot-rolled strip, the coiling temperature is preferably 720° C. or lower, and more preferably 700° C. or lower, such as below 630° C., preferably below 610° C., more preferably below 600° C.

On the other hand, when the coiling temperature is lower than 400° C., the strength of the hot-rolled steel strip increases excessively and makes cold-rolling difficult, and thus the coiling temperature is desirably 400° C. or higher and preferably 420° C. or higher, such as above 520° C. and preferably above 530° C.

However, even when coiling is performed at a temperature lower than 400° C., box annealing can be performed to soften the hot-rolled strip, and thus enable cold rolling or make cold rolling easier.

Next, the pickling process is performed to remove scale which has formed on the surface during hot-rolling. The hot-rolled steel strip after the pickling is subjected to cold-rolling for the purpose of thickness adjustment and shape correction. When cold-rolling is performed, a reduction is preferably set in the range of 30% to 80% so as to obtain a base steel strip having an excellent shape with high strip thickness precision. When the cold-rolling reduction is less than 30%, recrystallization of a ferrite phase is less likely to progress, and a non-recrystallized ferrite phase is retained in the microstructure after the continuous annealing process, which may result in a decrease in bending workability. Therefore, it is preferable that the rolling reduction of cold-rolling be 40% or more. On the other hand, in cold-rolling with a reduction of more than 80%, the cold-rolling load becomes too large and makes the cold rolling difficult. Thus, the reduction is preferably 80% or less. The reduction in the cold-rolling is also used to obtain the desired thickness of the surface layer. Preferably the cold-rolling reduction is above 44%, preferably above least 45%. Preferably the cold-rolling reduction is at below 70%, preferably below 67%.

Next, as a heat treatment step, an annealing step is performed (see FIG. 3). In a continuous annealing process, a cold-rolled steel strip is heated to a temperature T1 in a range of 680 to 720° C. at an average heating rate V1 of 5° C./s or more, and then at an average heating rate V2 of 0.1 to 4° C./s to a temperature T2 in a range of (Ac₁+40° C.) to (Ac₃+50° C.) and then held for a time t2 of 1 to 120s. The steel strip is then cooled to a temperature T3 in a range of 600 to 760° C. at an average cooling rate V3 of 0.1° C./s to 10° C./s, and then is cooled to a temperature T4 in a range of 450° C. or lower at an average cooling rate V4 of 5° C./s to 100° C./s, and is held in a temperature T5 in a range of 350 to 500° C. for a time t5 of 15 seconds to 200 seconds.

The cold-rolled steel strip is heated to T2 temperature by a two-stage heating. A higher heating rate V1 to T1 (680 to 720° C.) is applied to fit the capacity of a production line as there is no significant microstructure change in this stage. In the case where the average heating rate of V1 is less than 5° C./s, a furnace which is longer than usual is needed, which results in an increase in cost and a decrease in productivity. A slower heating rate V2 of 0.1 to 4° C./s from T1 to T2 is applied to control the recrystallization of ferrite. If V2 is higher than 4° C./s, recrystallization of ferrite is not complete, which deteriorates the bendability of the steel. If V2 is less than 0.1° C./s, there is coarsening of the ferrite, particularly in the surface layer of a steel strip due to the progress of recrystallization, which may result in a decrease in bendability.

The steel strip is subjected to isothermal heating at T2 above (Ac₁+40° C.) and below (Ac₃+50° C.) to form a mixed ferritic and austenitic two-phase structure or a full austenitic microstructure. Heating at a lower temperature may require a long period of time to completely redissolve the cementite and the volume fraction of the austenite formed during the annealing is small, while heating at a higher temperature increases the grain size of austenite. The Ac₁ and Ac₃ transformation points are determined using dilatation tests by applying a heating rate which is typical for the chosen annealing line as not all annealing lines have the same thermal capabilities. For example the critical phase transformation points, Ac₁, Ac₃, and Ms can be determined from a dilatation test in which the sample is heated at 15° C./s to 700° C., then at 1.5° C./s to 1200° C. and austenitized for 65 s and finally quenched (at cooling rate of 100° C./s) to room temperature. Such a heating profile is frequently used in a continuous annealing line. An analysis of the dilatation versus temperature curve yields the critical temperatures (see FIG. 4 for an example).

The holding time t2 at T2 is set from 1 second to 120 seconds. When the holding time is too short, the time for dissolving the carbides is insufficient and a sufficient amount of austenite cannot be secured, the fraction of the hard structure becomes small and thus, it is difficult to secure a high strength. Thus, the lower limit of the time at the annealing temperature is set to 1 second. On the other hand, the holding time longer than 120 seconds is not preferable since the effect is saturated and there is a tendency for grain growth. Therefore, the upper limit of the annealing temperature is set to 120 seconds.

The steel strip is then cooled to a temperature T3 in a range of 600 to 760° C. at an average cooling rate V3 of 0.1° C./s to 10° C./s, and then is cooled to a temperature T4 in a range of 450° C. to 200° C. at an average cooling rate V4 of 10° C./s to 100° C./s.

A slow cooling rate V3 of 0.1 to 10° C./s is applied to grow the ferrite grains and increase the C concentration of the austenite phase sufficiently. When the average cooling rate is lower than 0.1° C./s in the temperature range of T2 and T3, the holding time in the temperature range becomes longer and a large amount of ferrite and pearlite is generated. When the average cooling rate is higher than 10° C./s, an insufficient amount of ferrite is generated.

A rapid cooling rate V4 of 10° C./s or greater is used to minimize pearlite transformation of austenite. By performing rapid cooling to T4, it is possible to control the fraction of a ferrite phase and a bainite phase and/or a (partitioned) martensite phase. In the case where the average cooling rate is less than 10° C./s, since an excessive amount of ferrite phase is produced during cooling, the fraction of a bainite phase and/or a (partitioned) martensite phase becomes less, which results in a decrease in strength. On the other hand, when the cooling rate is higher than 100° C./s there is a concern of increased temperature unevenness in the strip. Therefore, the average cooling rate of this cooling operation is set to be 100° C./s or less.

The cooling stop temperature T4 is preferably between 200 to 450° C. to initiate the formation of bainitic ferrite and/or martensite. Depending on the composition of the steel, bainite or martensite can form. If T4 is higher, bainite will form and if T4 is lower, martensite will form. The lower the T4 is, the larger the volume fraction of martensite becomes. The martensite accelerates the bainitic transformation and is transformed to partitioned martensite in the following overaging. If T4 is higher than 450° C., high temperature bainite ferrite may form before going to overageing, which decrease the strength due to large bainitic ferrite grain size. Thus, the upper limit of the cooling stop temperature is desirably 450° C. or lower. However, if T4 is below 200° C., the amount of untransformed austenite will be too low, thereby minimizing the TRIP effect and associated ductility of the obtained product. Thus, the lower limit of the cooling stop temperature is desirably 200° C. or higher.

The steel strip is then heated within a time t4 to a temperature T5 ranging from 350° C. to 500° C. and overaged at T5 for a period t5 ranging from 15 seconds to 200 seconds. The duration of the time period t4 should be controlled within 1 to 10s, preferably within 1 to 5s. Although the time t4 is not critical for the microstructural properties, limitation of the typical available production lines requires a short holding time at t4 such that sufficient time is left for the overageing step to complete bainitic transformation and to stabilize the retained austenite. At T5, C partitioning occurs between the bainitic ferrite or martensite and untransformed austenite. The martensite transforms to partitioned martensite and the untransformed austenite continues to transform into carbide-free bainitic ferrite. The average carbon content in the retained austenite is increased as the time t5 is increased, so that retained austenite is made more stable.

If T5 exceeds 500° C., carbides may precipitate in the remaining austenite at the grain boundaries, and thus, the austenite becomes less stable and cracking is facilitated during the bending. If T5 is below 350° C. the degree of C partitioning is insufficient and the carbon concentration in retained austenite is not high enough to stabilize it in a limited time, which is a known constrain in typical available production lines.

The overageing time t5 is set to be from 15 seconds to 200 seconds is to allow the partial transformation of austenite into bainitic ferrite and to allow C enrichment in the retained austenite but to avoid the formation of carbides. When t5 is less than 15s, the bainitic transformation may not progress sufficiently, the partitioning of martensite is insufficient, the desired microstructure may not be obtained, and thus good formability of the steel strip is not be sufficiently ensured. When t5 is longer than 150 seconds, carbides tend to precipitate in non-transformed austenite, which decreases the carbon content in the retained austenite. A shorter t5 is applied for a higher T5. It is not necessary that the holding temperature T5 is constant as long as the temperature stays inside the range described. Actually, T5 might gradually increase due to the latent heat produced by bainitic transformation or slowly reduce due to heat loss.

Here, in these heating treatments and cooling treatments, the overageing not only includes isothermal holding in the temperature range, but also slow heating and slow cooling in the temperature range. There is no problem even in the case where the cooling rates or the heating rates vary during cooling or heating as long as the cooling rates and heating rates are within the specified ranges.

After overageing the strip is optionally galvanised at a temperature T6 and cooled, or cooled immediately after overageing without galvanising.

The cooling rate after overageing may be cooled in sections with different cooling rates V7 and V8 depending on the annealing line's lay-out and the intended microstructure. The resulting cold-rolled steel strip after annealing has a mixed structure composed of ferrite, bainitic ferrite or partitioned martensite, retained austenite and fresh martensite.

The above-described annealing may be performed, in place of a continuous annealing line, in a continuous galvanizing line having a constant temperature zone with a length corresponding to 30 seconds or longer.

The steel product may further be subjected to a further heat treatment after the coating process, such as galvannealing or when no hot-dip coating occurs, the steel may undergo subsequent electrodeposition of a metallic coating.

As an example, a hot dip coating process, such as a Zn coating process, can be integrated in the overageing process (section T6/t6 in FIG. 4). The hot dip galvanizing bath temperature T_{bath} is set to 460 to 500° C. for coating layer alloying. The coating step takes to 1 to 30s. When the overageing temperature T5 is less than (T_{bath}−40° C.), a large amount of heat is released at the time of the steel strip entering the galvanizing bath, and some of molten zinc is solidified to deteriorate the appearance of plating. The steel strip may be reheated before plating bath immersion to increase the strip temperature to (T_{bath}-40° C.) or higher so that the steel strip is immersed in the plating bath.

The Zn coating can be also a separate process after step 8 when step 6 is not applied. In this case, the annealed steel strip or sheet is heated to the Zn bath temperature and hot dip galvanized. Zn coating can be done in less than 20s, which does not have a significant effect on the base microstructure.

Advantageously the zinc-based coating is a galvanised or galvannealed coating. The Zn based coating may comprise a Zn alloy containing Al as an alloying element. A preferred zinc bath composition contains 0.10-0.35 wt. % Al, the remainder being zinc and unavoidable impurities. Another preferred Zn bath comprising Mg and Al as main alloying elements has the composition: 0.5-3.8 wt. % Al, 0.5-3.0 wt % Mg, optionally at most 0.2% of one or more additional elements; the balance being zinc and unavoidable impurities. Additional elements are Pb, Sb, Ti, Ca, Mn, Sn, La, Ce, Cr, Ni, Zr or Bi.

Preferably the alloying element contents in the zinc-alloy coating layer shall be 1.0-2.0% Mg and 1.0-3.0% Al, optionally at most 0.2% of one or more additional elements, unavoidable impurities and the remainder being zinc. In an even more preferred embodiment the zinc alloy coating comprises at most 1.6% Mg and between 1.6 and 2.5% Al, optionally at most 0.2% of one or more additional elements, unavoidable impurities and the remainder being zinc.

In another embodiment the steel strip, strip or blank is provided with a (commercially pure) aluminium layer or an aluminium alloy layer. A typical metal bath for a hot dip coating such an aluminium layer (Al) comprises of aluminium alloyed with silicon (Al—Si) e.g. aluminium alloyed with 8 to 11 wt. % of silicon and at most 4 wt. % of iron, optionally at most 0.2 wt. % of one or more additional elements such as calcium, unavoidable impurities, the remainder being aluminium. Silicon is present in order to prevent the formation of a thick iron-intermetallic layer which reduces adherence and formability. Iron is preferably present in amounts between 1 and 4 wt. %, more preferably at least 2 wt. %. Since the metal bath for Al or Al—Si has to be at a temperature of about 600° C. it is difficult to integrate in the annealing process and therefore it is preferable that the coating step is performed in a separate consecutive hot dip-coating process or by electroplating.

For the purpose of lubricating the surface or the like, a coating film including at least one of a phosphorus oxide and a composite oxide containing phosphorus may be formed on the surface of the cold-rolled steel strip of the present invention or the plated layer surface of the galvanized steel strip.

Skin pass (temper) rolling may be performed after the annealing and optionally zinc coating to fine tune the tensile properties and modify the surface appearance and roughness depending on the specific requirements resulting from the intended use. The reduction is preferably within a range of 0.1% to 1.5%. When the reduction is less than 0.1% the effect is small and the control is difficult, and thus, 0.1% is set as the lower limit. When the reduction is more than 1.5%, productivity is significantly decreased and thus, 1.5% is set as the upper limit. Preferably the reduction is at most 0.70% or at most 0.45%. A minimum reduction may be used to improve the surface texture of the coated strip and/or to suppress the yield point elongation (YPE) and/or to increase the yield strength (Rp) of the material.

The skin pass may be performed either in-line or off-line. In addition, the skin pass rolling can be performed under a desired reduction in a single pass or a number of passes. Finally, the resulting steel strips may be coated with resin or oil.

In an embodiment the method according to the invention comprises providing the strip with a coating film on at least one side of the strip including at least one of a phosphorus oxide, and a composite oxide containing phosphorus on the surface of the cold-rolled and annealed steel strip or on the surface of the metallic coating on the steel strip.

In an embodiment, if the hot-rolled strip is cooled and coiled at a coiling temperature below 400° C., then the coiled and cooled hot-rolled strip may be subjected to a box-annealing treatment to soften the hot-rolled strip prior to cold-rolling.

### Examples

The invention will now be described with reference to the following non-limiting examples.

Steels having compositions as shown in Table 1 were cast into 25 kg ingots of 200 mm×110 mm×110 mm in dimensions using vacuum induction. The following process schedule was used to manufacture cold-rolled strips of 1 mm thickness:
Reheating of the ingots at 1225° C. for 2 hours;
Rough rolling of the ingots from 140 mm to 35 mm;
Reheating of the rough-rolled ingots at 1200° C. for 30 min;
Hot-rolling from 35 mm to 4 mm in 6 passes;
Run-out-table cooling: cool from finish rolling temperature (FRT) about 850 to 900° C. to 600° C. at a rate of 40° C./s;
Furnace cooling: strips transferred to a preheated furnace at 600° C. and then cooled to room temperature to simulate the coiling process;
Pickling: The hot-rolled strips were then pickled in HCl at 85° C. to remove the oxide layers;
Cold-rolling: The hot-rolled strips were cold-rolled to 1 mm strips;
Heat treating according to the invention with process parameters as listed in Tables 2a and 2b

Cold-rolled sheets with suitable size were subjected to a continuous annealing cycle and samples for microstructure observations, tensile tests and bending tests were machined from the heat-treated sheets.

Dilatometry was done on the cold-rolled samples of 10 mm×5 mm×1 mm dimensions (length along the rolling direction). Dilatation tests were conducted on a Bahr dilatometer type DIL 805. All measurements were carried out in accordance with September 1680. The critical phase transformation points Ac₁, Ac₃ and Ms were determined from the quenched dilatometry curves.

The microstructure was determined by optical microscopy (OM) using the commercially available image-processing program Leica QwinPro V3.5.1. The volume fractions of ferrite, pearlite, bainite, cementite, partitioned martensite and fresh martensite were determined by equating the volume fraction to the area fraction and measuring the area fraction from a polished surface on the thickness cross section parallel to the rolling direction (plane with normal in transverse direction) of a steel strip. The polished cross section was etched by using a 3%-nital solution. Under optical microscopy, ferrite is revealed as white, pearlite and carbide are revealed as black, fresh martensite is revealed as straw colour, a mixture of bainitic ferrite and partitioned martensite is revealed as grey.

The base microstructure was observed at a position located at ¼ of the thickness of the steel strip. The thickness of the surface layer is determined from the surface of the steel strip or sheet to the position where the ferrite area is 90%.

The volume fraction of retained austenite and carbides of the base microstructures were determined by X-ray diffraction (XRD) according to DIN-EN13925 on a D8 Discover GADDS (Bruker AXS). The XRD measurements were conducted on a plane parallel to the street surface at ¼ thickness of the steel strip. The steel strip was mechanically and chemically polished and was then analyzed by measuring the integral intensity of each of the (200) plane, (220) plane, and (311) plane of FCC iron and that of the (200) plane, (211) plane, and (220) plane of bcc iron with an X-ray diffractometer using Co-Ka radiation. The amount of retained austenite (RA) and the lattice parameter in the retained austenite were determined using Rietveld analysis. The C-content in the retained austenite is calculated using the formula (D. Dyson and B. Holmes, Effect of alloying additions on the lattice parameter austenite, J. Iron Steel Inst. 208 (1970) 469-474):

$$C = ( a - 3.572 - 0.0012 Mn + 0.00157 Si - 0.0056 Al ) / 0.033 \qquad ( 2 )$$

Where a is the lattice parameter of the retained austenite in angstrom [Å], and C, Mn and Al are in wt. %.

Tensile tests—JIS5 test pieces (gauge length=50 mm; width=25 mm) were machined from the annealed strips such that the tensile direction was parallel to the rolling direction. Room temperature tensile tests were performed in a Schenk TREBEL testing machine following NEN-EN10002-1:2001 standard to determine tensile properties (yield strength YS (MPa), ultimate tensile strength UTS (MPa), total elongation TE (%)). For each condition, three tensile tests were performed, and the average values of mechanical properties are reported.

Bending specimens (40 mm×30 mm×1.0 mm) taken parallel and transverse to the rolling direction were prepared from each of the conditions and tested until fracture with the three-point bending test according to the VDA 238-100 standard. The samples with bending axis parallel to the rolling direction are identified as longitudinal (L) bending specimens whereas those with bending axis perpendicular to the rolling direction are denoted as perpendicular (T) bending specimens. For each type of test, three samples were tested and the results were averaged.

### BRIEF DESCRIPTION OF THE DRAWINGS

The invention will now be explained by means of the following, non-limiting figures.

FIG. 1 shows depth profile of the C element in strips (A55-A58) analysed using glow discharge optical emission spectroscopy (GDOES).

FIG. 2 shows the depth of the surface layer as a function of the Al content.

FIG. 3 shows the annealing cycle.

FIG. 4 is a dilatometer curve of steel A55 showing the determination of Ac₁, Ac₃ and Ms.

FIG. 5 shows the steel strip(S) with its base layer (1) and provided with a surface layer (2) on each side and further provided with the optional metallic coating (3) on each side.

FIG. 6 shows the microstructure of steel A56 after process P1 showing surface decarburized layer measurements.

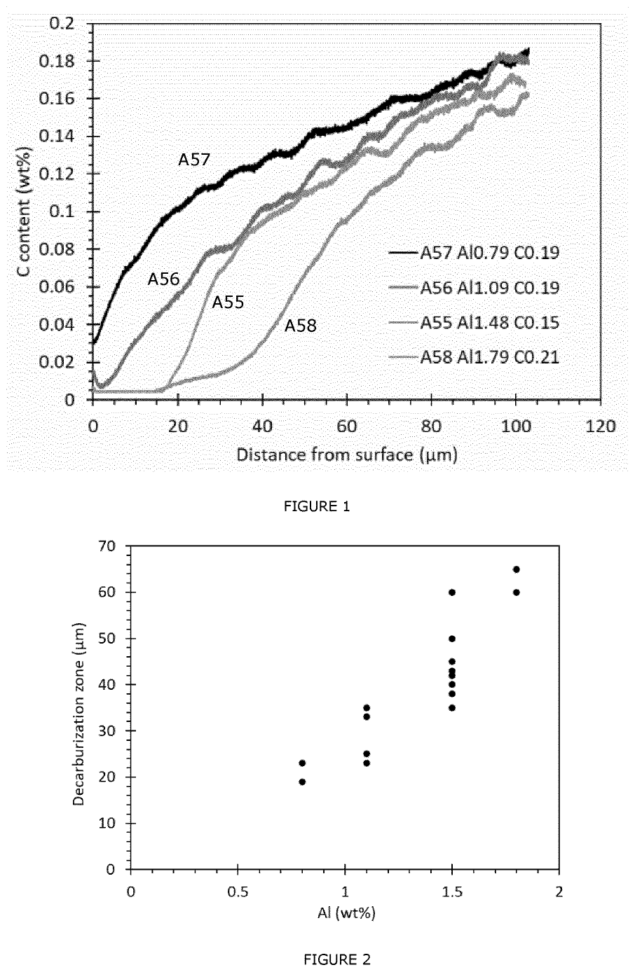

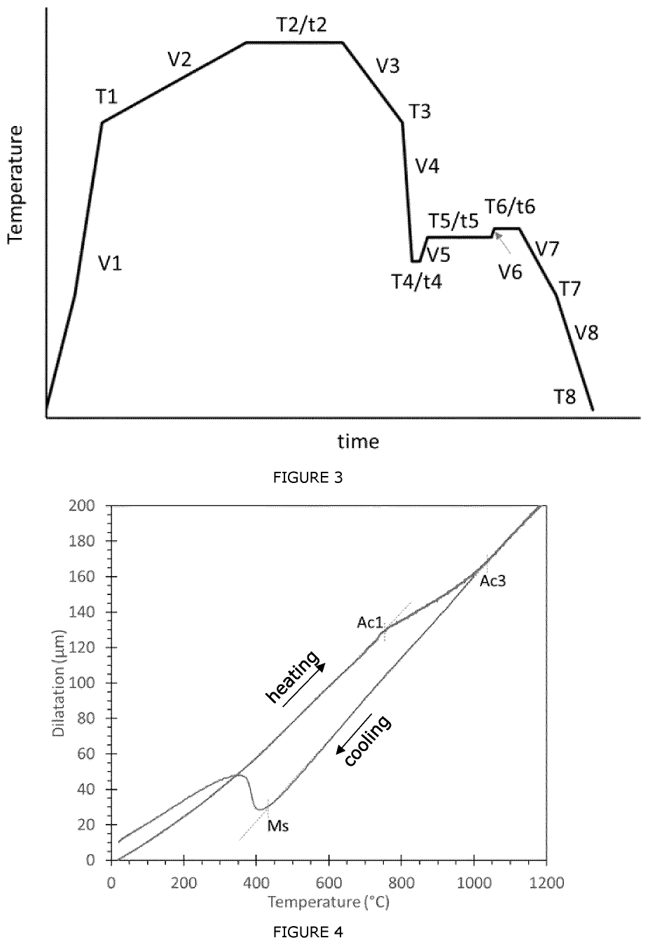

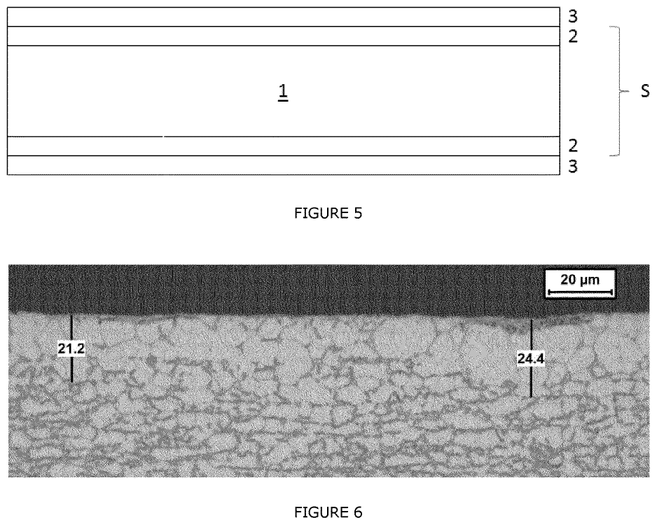

TABLE 1
Chemical compositions.

| Steel | C | Mn | Al | Si | Cr | Ni | Cu | S | P | Ti | Note |
|---|---|---|---|---|---|---|---|---|---|---|---|
| A52 | 0.075 | 2.346 | 1.056 | 1.016 | 0.050 | 0.020 | 0.030 | 0.002 | 0.007 | 0.003 | Comp. |
| A53 | 0.124 | 1.571 | 1.470 | 0.985 | 0.040 | 0.010 | 0.020 | 0.002 | 0.005 | 0.002 | Inv. |
| A54 | 0.151 | 1.552 | 1.480 | 0.592 | 0.040 | 0.007 | 0.020 | 0.002 | 0.006 | 0.005 | Inv. |
| A55 | 0.190 | 1.756 | 1.496 | 0.296 | 0.030 | 0.008 | 0.030 | 0.003 | 0.005 | 0.004 | Inv. |
| A56 | 0.193 | 1.774 | 1.088 | 0.697 | 0.050 | 0.010 | 0.010 | 0.003 | 0.006 | 0.003 | Inv. |
| A57 | 0.191 | 1.775 | 0.793 | 0.983 | 0.040 | 0.009 | 0.020 | 0.002 | 0.005 | 0.006 | Inv. |
| A58 | 0.210 | 1.179 | 1.796 | 0.051 | 0.030 | 0.080 | 0.030 | 0.002 | 0.007 | 0.005 | Inv. |
| A59 | 0.210 | 1.950 | 1.500 | 0.098 | 0.020 | 0.070 | 0.030 | 0.002 | 0.005 | 0.002 | Inv. |
| V10 | 0.193 | 1.844 | 0.007 | 1.484 | 0.040 | 0.010 | 0.020 | 0.003 | 0.006 | 0.002 | Comp. |
| V11 | 0.215 | 1.779 | 0.518 | 0.994 | 0.030 | 0.020 | 0.050 | 0.004 | 0.007 | 0.003 | Inv. |
| V12 | 0.170 | 1.814 | 0.953 | 0.526 | 0.040 | 0.010 | 0.040 | 0.005 | 0.005 | 0.002 | Inv. |
| V13 | 0.172 | 1.947 | 1.263 | 0.029 | 0.050 | 0.030 | 0.030 | 0.003 | 0.006 | 0.004 | Inv. |

| Steel | Nb | Mo | V | B | N | Al + Si | Ac1 (° C.) | Ac3 (° C.) | Ms (° C.) | Note |
|---|---|---|---|---|---|---|---|---|---|---|
| A52 | 0.002 | 0.004 | 0.002 | 0.0004 | 0.0029 | 2.072 | 735 | 1130 | 466 | Comp. |
| A53 | 0.003 | 0.005 | 0.003 | 0.0004 | 0.0034 | 2.455 | 742 | 1160 | 450 | Inv. |
| A54 | 0.003 | 0.009 | 0.002 | 0.0004 | 0.0047 | 2.072 | 740 | 1115 | 452 | Inv. |
| A55 | 0.002 | 0.005 | 0.002 | 0.0006 | 0.0050 | 1.792 | 740 | 1035 | 430 | Inv. |
| A56 | 0.003 | 0.005 | 0.003 | 0.0004 | 0.0047 | 1.785 | 740 | 995 | 415 | Inv. |
| A57 | 0.002 | 0.004 | 0.004 | 0.0007 | 0.0043 | 1.776 | 740 | 980 | 420 | Inv. |
| A58 | 0.002 | 0.005 | 0.003 | 0.0004 | 0.0035 | 1.847 | 743 | 1076 | 460 | Inv. |
| A59 | 0.006 | 0.005 | 0.002 | 0.0004 | 0.0020 | 1.598 | 740 | 990 | 398 | Inv. |
| V10 | 0.002 | 0.005 | 0.001 | 0.0002 | 0.0043 | 1.491 | 728 | 855 | 347 | Comp. |
| V11 | 0.003 | 0.004 | 0.008 | 0.0002 | 0.0042 | 1.512 | 730 | 876 | 358 | Inv. |
| V12 | 0.009 | 0.003 | 0.002 | 0.0003 | 0.004 | 1.479 | 732 | 915 | 362 | Inv. |
| V13 | 0.004 | 0.005 | 0.002 | 0.0003 | 0.0045 | 1.292 | 736 | 948 | 366 | Inv. |

* Other elements were at residual level: Zr <0.001, Ca <0.0002.

TABLE 2a
Process parameters used in heat treatments.

| | | V2 | T2 | V3 | T3 | V4 | T4 | t4 | V5 | T5 | t5 | V6 |
|---|---|---|---|---|---|---|---|---|---|---|---|---|
| Steel | Process | ° C./s | ° C. | ° C./s | ° C. | ° C./s | ° C. | s | ° C./s | ° C. | s | ° C./s |
| A52 | P1 | 0.8 | 800 | −2 | 720 | −46.2 | 420 | 0 | 0 | 420 | 53 | 9.5 |
| to | P2 | 1.2 | 840 | −3 | 720 | −46.2 | 420 | 0 | 0 | 420 | 53 | 9.5 |
| A59 | P3 | 1.7 | 880 | −3.9 | 720 | −46.2 | 420 | 0 | 0 | 420 | 53 | 9.5 |
| V10 | P4 | 1.5 | 870 | −3.7 | 720 | −43 | 440 | 0 | 0 | 440 | 53 | 9.5 |
| V10 | P5 | 1.5 | 870 | −3.7 | 720 | −68 | 280 | 5 | 32 | 440 | 43 | 9.5 |
| V11 | P6 | 1.5 | 870 | −3.2 | 740 | −46 | 440 | 0 | 0 | 440 | 53 | 9.5 |
| V11 | P7 | 1.5 | 870 | −3.7 | 720 | −46 | 420 | 0 | 0 | 420 | 53 | 19 |
| V11 | P8 | 1.7 | 880 | −3.9 | 720 | −43 | 440 | 0 | 0 | 440 | 53 | 9.5 |
| V11 | P9 | 1.7 | 880 | −3.9 | 720 | −64 | 300 | 5 | 28 | 440 | 43 | 9.5 |
| V12 | P10 | 1.4 | 860 | −3.4 | 720 | −43 | 440 | 0 | 0 | 440 | 53 | 9.5 |
| V12 | P11 | 1.7 | 880 | −3.2 | 740 | −49 | 420 | 0 | 0 | 420 | 53 | 19 |
| V12 | P12 | 2 | 915 | −4.8 | 720 | −43 | 440 | 0 | 0 | 440 | 53 | 9.5 |
| V12 | P13 | 2 | 915 | −4.8 | 720 | −62 | 320 | 5 | 24 | 440 | 43 | 9.5 |
| V13 | P14 | 1.4 | 860 | −3.4 | 720 | −43 | 440 | 0 | 0 | 440 | 53 | 9.5 |
| V13 | P15 | 1.7 | 880 | −3.2 | 740 | −49 | 420 | 0 | 0 | 420 | 53 | 19 |
| V13 | P16 | 2.2 | 935 | −5.3 | 720 | −43 | 440 | 0 | 0 | 440 | 53 | 9.5 |
| V13 | P17 | 2.2 | 935 | −5.3 | 720 | −62 | 320 | 5 | 24 | 440 | 43 | 9.5 |

TABLE 2b
Rest of the parameters

| V1 | T1 | t2 | T6 | t6 | V7 | T7 | V8 | T8 |
|---|---|---|---|---|---|---|---|---|
| ° C./s | ° C. | s | ° C./s | s | ° C. | ° C. | ° C./s | ° C. |
| 23 | 720 | 65 | 460 | 17 | −6.5 | 300 | −11.3 | 20 |

TABLE 3
Microstructures of the cold rolled strips after heat treatment

| | | Inner microstructure | | | | | Thickness of |
|---|---|---|---|---|---|---|---|
| | | | | | | C of | surface |
| Steel | Process | F (%) | BF (%) | FM (%) | RA (%) | RA (wt. %) | layer (μm) |
| A52 | P1 | 82.5 | 8.5 | 6.5 | 2.5 | 0.63 | 24.5 |
| | P2 | 79.9 | 11.9 | 4.7 | 3.5 | 0.69 | 25.2 |
| | P3 | 78.1 | 13.9 | 2.6 | 4.3 | 0.74 | 25.8 |
| A53 | P1 | 84.7 | 1.7 | 4.5 | 9.1 | 1.01 | 28.5 |
| | P2 | 82.8 | 5 | 3.6 | 8.6 | 1.06 | 29.2 |
| | P3 | 80.5 | 8.4 | 2.5 | 8.6 | 1.07 | 30 |
| A54 | P1 | 84.6 | 2 | 3 | 10.4 | 1.16 | 27.5 |
| | P2 | 81.2 | 6.1 | 2.4 | 10.3 | 1.18 | 26.4 |
| | P3 | 78.8 | 9.6 | 1.2 | 10.4 | 1.22 | 28.2 |
| A55 | P1 | 73.1 | 9.2 | 2.8 | 14.9 | 1.1 | 28.5 |
| | P2 | 71.3 | 12.8 | 2.4 | 13.5 | 1.17 | 29.2 |
| | P3 | 69.5 | 15.9 | 1.5 | 13.1 | 1.19 | 30 |
| A56 | P1 | 81.6 | 2.1 | 0.2 | 16.1 | 1.05 | 23.4 |
| | P2 | 78.4 | 5.9 | 1.2 | 14.5 | 1.12 | 23.8 |
| | P3 | 76.5 | 7.8 | 2.3 | 13.4 | 1.14 | 24.2 |
| A57 | P1 | 81 | 0.1 | 3.2 | 15.7 | 1.05 | 19.1 |
| | P2 | 78.2 | 4.7 | 2.7 | 14.4 | 1.1 | 19.5 |
| | P3 | 75.9 | 8.8 | 2.1 | 13.2 | 1.12 | 20.3 |
| A58 | P1 | 84.5 | 1.2 | 2.5 | 11.8 | 1.47 | 32.5 |
| | P2 | 82.8 | 4.2 | 2 | 11 | 1.5 | 33.2 |
| | P3 | 81 | 6.3 | 1.8 | 10.9 | 1.5 | 34 |
| A59 | P1 | 65.9 | 12 | 3.5 | 18.6 | 1.02 | 26.6 |
| | P2 | 63.6 | 16.5 | 2.8 | 17.1 | 1.07 | 26.9 |
| | P3 | 62.5 | 19.4 | 2.5 | 15.6 | 1.11 | 27.5 |

TABLE 4
Microstructures of the cold-rolled strips after heat treatment.

| | | Inner microstructure | | | | | | Thickness of |
|---|---|---|---|---|---|---|---|---|
| Steel | | | BF + PM | FM | RA | C of RA | | surface layer |
| code | Process | F (%) | (%) | (%) | (%) | (wt. %) | M₃C(%) | (μm) |
| V10 | P4 | 10 | 70 | 4.8 | 15.2 | 1.11 | | 13.5 |
| V10 | P5 | 5 | 82.8 | 2.5 | 9.7 | 1.09 | | 13.8 |
| V11 | P6 | 43 | 41 | 2.9 | 13.1 | 1.23 | | 22.6 |
| V11 | P7 | 34 | 50 | 2.4 | 13.6 | 1.23 | | 22.5 |
| V11 | P8 | 30 | 51 | 2.3 | 16.7 | 1.26 | | 22.8 |
| V11 | P9 | 18 | 71.6 | 0 | 10.4 | 1.32 | | 23.7 |
| V12 | P10 | 69 | 12 | 1 | 18 | 1.28 | | 26.2 |
| V12 | P11 | 67 | 16 | 1.5 | 15.5 | 1.3 | | 25.5 |
| V12 | P12 | 32 | 51 | 1 | 16 | 1.46 | | 26.4 |
| V12 | P13 | 27 | 63.7 | 0 | 9.3 | 1.5 | | 27.1 |
| V13 | P14 | 73 | 9 | 2.2 | 15.8 | 1.38 | | 30.1 |
| V13 | P15 | 72 | 12.5 | 1 | 14.5 | 1.41 | | 28.5 |
| V13 | P16 | 31 | 54 | 1.4 | 13.6 | 1.6 | | 29.2 |
| V13 | P17 | 24 | 63 | 8.5 | 5.1 | 1.66 | 1.4 | 27.6 |

TABLE 5
Tensile properties and bendability of the
cold rolled strip after heat treatment.

| | | YS | UTS | TE | UTS*TE | BA-L | BA-D |
|---|---|---|---|---|---|---|---|
| Steel | Process | (MPa) | (MPa) | (%) | (MPa %) | (°) | (°) |
| V10 | P4 | 684 | 1065 | 10.1 | 10758 | 75 | 82 |
| V10 | P5 | 1091 | 1239 | 9.8 | 12144 | 78 | 80 |
| V11 | P6 | 678 | 977 | 20.5 | 20018 | 105 | 110 |
| V11 | P7 | 608 | 958 | 23.1 | 22130 | 110 | 115 |
| V11 | P8 | 643 | 956 | 23.1 | 22133 | 115 | 116 |
| V11 | P9 | 804 | 1150 | 19.2 | 22080 | 113 | 114 |
| V12 | P10 | 475 | 846 | 28.9 | 24422 | 116 | 116 |
| V12 | P11 | 522 | 832 | 30.0 | 24972 | 120 | 125 |
| V12 | P12 | 576 | 843 | 25.4 | 21402 | 121 | 124 |
| V12 | P13 | 946 | 1055 | 19.8 | 20888 | 122 | 126 |
| V13 | P14 | 497 | 779 | 33.2 | 25905 | 123 | 125 |
| V13 | P15 | 524 | 752 | 32.3 | 24290 | 125 | 127 |
| V13 | P16 | 567 | 741 | 29.8 | 22087 | 126 | 126 |
| V13 | P17 | 894 | 1018 | 21.2 | 21585 | 128 | 127 |

TABLE 6
Tensile properties and bendability of the cold rolled strips after heat treatments

| | | YS | UTS | TE | UTS*TE | BA-L | BA-D | UTS*TE*BA_{avg} |
|---|---|---|---|---|---|---|---|---|
| Steel | Process | (MPa) | (MPa) | (%) | (MPa %) | (°) | (°) | (MPa %°) |
| A52 | P1 | 349 | 788 | 19.2 | 15121 | 113 | 115 | 1723794 |
| | P2 | 344 | 768 | 17.9 | 13746 | 115 | 120 | 1615155 |
| | P3 | 331 | 724 | 20.2 | 14618 | 108 | 109 | 1586053 |
| A53 | P1 | 315 | 677 | 28.3 | 19155 | 118 | 117 | 2250713 |
| | P2 | 349 | 666 | 27.7 | 18471 | 115 | 116 | 2133401 |
| | P3 | 350 | 633 | 30.5 | 19338 | 112 | 118 | 2223870 |
| A54 | P1 | 381 | 664 | 29.1 | 19329 | 118 | 122 | 2319480 |
| | P2 | 385 | 633 | 34.4 | 21738 | 119 | 120 | 2597691 |
| | P3 | 386 | 622 | 35.0 | 21749 | 120 | 121 | 2620755 |
| A55 | P1 | 392 | 706 | 31.3 | 22090 | 115 | 120 | 2595575 |
| | P2 | 413 | 693 | 34.1 | 23640 | 112 | 117 | 2706780 |
| | P3 | 400 | 676 | 34.0 | 22972 | 116 | 121 | 2722182 |
| A56 | P1 | 433 | 771 | 29.6 | 22835 | 114 | 117 | 2637443 |
| | P2 | 425 | 764 | 27.7 | 21161 | 118 | 119 | 2507579 |
| | P3 | 391 | 756 | 30.1 | 22800 | 116 | 118 | 2667600 |
| A57 | P1 | 400 | 848 | 26.1 | 22109 | 117 | 119 | 2608862 |
| | P2 | 409 | 794 | 31.6 | 25081 | 115 | 116 | 2896856 |
| | P3 | 389 | 778 | 28.7 | 22289 | 113 | 118 | 2574380 |
| A58 | P1 | 409 | 589 | 42.8 | 25190 | 119 | 123 | 3047990 |
| | P2 | 390 | 580 | 36.8 | 21363 | 121 | 124 | 2616968 |
| | P3 | 381 | 570 | 35.8 | 20422 | 122 | 125 | 2522117 |
| A59 | P1 | 493 | 807 | 26.0 | 20992 | 120 | 123 | 2550528 |
| | P2 | 489 | 761 | 30.1 | 22953 | 119 | 120 | 2742884 |
| | P3 | 449 | 753 | 26.5 | 19919 | 107 | 121 | 2270766 |

BA_{avg} = average of BA-L and BA-D.

1. A steel strip or sheet comprising a surface layer on each side of a base layer the base layer comprising, in wt. %:

| C: | 0.10-0.30 | 0.50 ≤ Si + Al ≤ 2.50 | |
|---|---|---|---|
| Mn: | 0.80-3.00 | S: | 0.0001-0.0300 |
| Si: | 0.010-1.50 | P: | 0.001-0.050 |
| Al: | 0.50-2.00 | N: | 0.0001-0.0100 |

and optionally one or more of the elements selected from:

| | | | |
|---|---|---|---|
| Cr: | 0-0.30 | Nb: | 0.005-0.10 |
| Mo: | 0-0.50 | Ti: | 0.005-0.10 |
| Ni: | 0-1.00 | Zr: | 0.010-0.10 |
| Cu: | 0-1.00 | Ca: | 0.0002-0.010 |
| V: | 0.005-0.20 | REM: | 0.010-0.10 |
| B: | 0.0005-0.0030 | Mg: | 0-0.050 |

the remainder being iron and unavoidable impurities,
wherein the surface layer consists of at least 90 vol. % of ferrite and at most 10 vol. % of other microstructures including partitioned martensite and bainitic ferrite, fresh martensite, residual austenite and carbides, and
wherein the microstructure of the base layer consists of 15 to 85 vol. % of ferrite, residual austenite of 5 to 20 vol. %, fresh martensite of 10 vol. % or less, and less than 5 vol. % of pearlite, where the sum of the partitioned martensite and bainitic ferrite is between 0 to 75 vol. %,
wherein the microstructure of the base layer is determined at ¼ thickness of the steel strip or sheet, wherein the amount of residual austenite is determined according to the method described in the description and
wherein the bending angle in the longitudinal direction, BA-L, and in the transverse direction, BA-T, of the steel strip or sheet is at least 100°, and
wherein the steel strip or sheet is optionally provided with a metallic coating on one or either side.

2. The steel strip or sheet according to claim 1, wherein the surface layers have a thickness of at least 15 μm and the two surface layers together comprises at most 10% of the thickness of the final cold-rolled sheet.

3. The steel strip or sheet according to claim 1 comprising a carbon content of 0.12-0.28%.

4. The steel strip according to claim 1 comprising a manganese content of 1.00-3.00%.

5. The steel strip according to claim 1 comprising a silicon content of at least 0.030%.

6. The steel strip according to claim 1 comprising an aluminium content of at most 1.80%.

7. The steel strip according to claim 1, wherein Si+Al is at least 1.00 wt %.

8. The steel strip according to claim 1, wherein the sulphur content S is at most 0.020 and/or the phosphorus content P is at most 0.025 and/or the nitrogen content N is at most 0.006.

9. The steel strip according to claim 1, wherein one or more or all of Cr, Mo, Ni, Cu, V, Nb, Zr, B, Ti, Ca and REM is present only as an impurity.

10. The steel strip or sheet according to claim 1 comprising, in wt. %:

| | | | |
|---|---|---|---|
| C: | 0.124-0.215 | Si: | 0.029-1.484 |
| Mn: | 1.179-2.346 | Si + Al: | 1.292-2.455 |
| Al: | 0.518-1.796 | N: | 0.0020-0.0050 |
| Cr: | at most 0.050 | Cu: | at most 0.050 |
| Ni: | at most 0.080 | | |

11. The steel strip or sheet according to claim 10 comprising, in wt. %:

| | | | |
|---|---|---|---|
| Cr: | 0.010-0.050 | Nb: | at most 0.010 |
| Ni: | 0.007-0.080 | Ti: | at most 0.005 |
| Cu: | 0.010-0.050 | Ca: | at most 0.0010 |

12. A method for producing a strip or sheet according to claim 1, comprising the following steps:
providing a hot-rolled steel strip by hot-rolling a continuously thick or thin cast slab with a composition comprising

| C: | 0.10-0.30 | 0.50 ≤ Si + Al ≤ 2.50 | |
|---|---|---|---|
| Mn: | 0.80-3.00 | S: | 0.0001-0.0300 |
| Si: | 0.010-1.50 | P: | 0.001-0.050 |
| Al: | 0.50-2.00 | N: | 0.0001-0.0100 |

and optionally one or more of the elements selected from:

| | | | |
|---|---|---|---|
| Cr: | 0-0.30 | Nb: | 0.005-0.10 |
| Mo: | 0-0.50 | Ti: | 0.005-0.10 |
| Ni: | 0-1.00 | Zr: | 0.010-0.10 |
| Cu: | 0-1.00 | Ca: | 0.0002-0.010 |
| V: | 0.005-0.20 | REM: | 0.010-0.10 |
| B: | 0.0005-0.0030, | Mg: | 0-0.050 |

the remainder being iron and unavoidable impurities, to a hot-rolled strip having a thickness of 2-6 mm, wherein finish-rolling is performed while the strip has an austenitic microstructure;
Cooling the hot-rolled strip after finish-rolling with an average cooling rate of at most 20° C./s in the temperature range of 800 to 700° C.;
Coiling the cooled hot-rolled strip at a coiling temperature CT below 750° C.;
Optionally, if the hot-rolled strip is coiled at a coiling temperature below 400° C., the coiled and cooled hot-rolled strip is subjected to a box-annealing treatment to soften the hot-rolled strip prior to cold-rolling;
Uncoiling the coiled hot-rolled strip, followed by pickling and cold-rolling with a reduction of 30-80%;
Annealing of the cold-rolled strip by subjecting it to continuous annealing comprising the following subsequent steps:
i. heating the strip to a temperature T1 in the range of 680-720° C. at an average heating rate V1 of at least 5° C./s;
ii. further heating of the strip with an average heating rate V2 of 0.1 to 4° C./s to a temperature T2 in the range of (Ac₁+40° C.) to (Ac₃+50° C.);
iii. holding strip at T2 for a time period t2 of between 1 and 120 s;
iv. cooling of the strip with an average cooling rate V3 in the range of 0.1-10° C./s to a temperature T3 in the range of 600-760° C.;
v. cooling the strip from T3 with an average cooling rate V4 in the range of 10-100° C./s to a temperature T4 in the range of 450° C. or lower;
vi. optionally reheating the strip from T4 to T5 at a heating rate V5;
vii. holding the strip at T5 in the range of 350-500° C. for a period t5 of 15-200 s;
viii. optionally hot dip coating the strip at a temperature T6;
ix. cooling the strip to ambient temperatures by still air cooling or by accelerated cooling including but not limited to forced air cooling, spray cooling or mist cooling;
Optionally cutting the strip into sheets.

13. The method according to claim 12, wherein the steel strip is a) hot-dip coating of the strip is directly followed by galvannealing, or b) the strip is metallically coated by electrodeposition.

14. The method according to claim 12, or 13 wherein the annealed strip is subjected to temper rolling or tension levelling.

15. A car or truck component, such as an automotive chassis or safety component, a B-pillar, a reinforcement (crash) part, a front crash beam, a seat member, a bumper part, a door part, a component of the body in white, a component of the frame or the sub-frame, an electric battery holder or container part, said component having been produced from the steel according to claim 1.

16. The steel strip or sheet according to claim 1 comprising a carbon content of 0.15-0.26%.

17. The steel strip according to claim 1 comprising a manganese content of 1.20-2.80%.

18. The steel strip according to claim 1 comprising an aluminium content of at most 1.70%.

19. The method according to claim 12, wherein the steel strip is a) hot-dip coating of the strip is directly followed by galvannealing, or b) the strip is metallically coated by electrodeposition, in a continuous processing step preceding the optional step of cutting the strip into sheets.

20. The method according to claim 12, wherein the annealed strip is subjected to temper rolling or tension levelling with a reduction of between 0.1 and 1.5%.
